(19) United States
(12) Patent Application Publication
(10) Pub. No.: US 2001/0048248 A1
(43) Pub. Date: Dec. 6, 2001

(54) Reenergy inductor/reenergy induction

(76) Inventor: Mathew Carter Patteson, Jr., Houston, TX (US)

Correspondence Address: Matthew Carter Patteson, Jr., 2412 S. Voss # F111, Houston, TX, 77057, US

(21) Appl. No.: 09/860,139

(22) Filed: May 17, 2001

Related U.S. Application Data
(60) Provisional application No. 60/209,560, filed on Jun. 6, 2000.

(51) Int. Cl. G21D 7/02; H02K 44/00

(52) U.S. Cl. 310/11

(57) ABSTRACT

A process for generation of electricity by means of electromagnetic induction, through a liquid-borne medium bearing magnetic material in powdered form. The present invention illustrating this process is comprised of bottom (b) and top (a) hollow hemispheres (one inch wall thickness), enclosing a coil-core assembly (FIG. 2) of metal and coiled wire, mounted on two equidistant notches (c) on the bottom hemisphere. Paraffin and powdered magnetite are solidified into place and the hemispheres mated with glue. The coil-core assembly is created from wire (h) wound on a manufactured metal piece (e) and fed through “tunnel holes” (f,g) drilled into the metal piece and leading outside the ends of the metal piece (h), out of the container housing. Wires from the coil-core assembly extrude and convey electricity, which is induced by a moving magnetic field formed by the boiling medium of magnetic material, when the invention is placed in an area of heat above approximately 360 degrees F.

### FEDERALLY SPONSORED RESEARCH

Not applicable

### SEQUENCE LISTING OR PROGRAM

Not applicable

### BACKGROUND

1. Field of Invention

This invention relates to generation of electricity, specifically use of available heat and magnetism to induce an electrical current (refer to provisional patent application number 60/209,560 (Jun. 6, 2000)).

2. Description of Prior Art

The most common method used for converting heat energy into usable electricity is steam production, the only prior art known to the inventor. This process involves extreme mechanical work by heavy metal turbines, which are turned by high-pressure steam devices to produce expensive electricity. The high cost of such energy reclamation from heat discourages investment in such conservation measures in most waste-heat situations. This adds to the overall high cost of electricity and power in the United States and the World.

Heat is disorganized energy, or entropy. Yet heat can be recycled to productive use through measures such as steam production, THE REENERGY INDUCTOR, and the general process of REENERGY INDUCTION. Because of the Second Law of Thermodynamics, however, there is always a certain degree of inefficiency in recycling heat to productive use. In the case of steam production, the sheer weight of the heavy equipment necessary to effect electromagnetic induction of a usable current militates against the efficiency of steam production of electricity. An alternative process for converting heat into electricity, which could prove simpler and at least as efficient, is desirable.

### OBJECTS And ADVANTAGES

Accordingly, several objects and advantages of the present invention are apparent:

(a) to reduce the number and complexity of mechanical and moving parts in the process and machines converting heat into electrical energy;

(b) to provide an efficient method of heat reclamation for the purpose of producing electricity;

(c) to provide a relatively inexpensive way for commercial, residential and recreational conversion of “waste” heat into usable electricity which can be fed into a commercial, residential or recreational “power grid;”

(d) to provide a method superior to mechanically-intensive steam production or other prior art for the conversion of heat into electricity;

(e) to provide a better machine and process for low cost reclamation of heat and its conversion into electricity, with a minimum of heavy, moving parts;

(f) to encourage heat reclamation and energy conservation and to support federal, state and local policies concerning energy usage; and

(g) to help alleviate some contemporary energy-related problems such as high cost, “rolling blackouts,” and waste of heat (an undervalued resource).

Still further objects and advantages of this invention, both as a process and as embodied in the device presented herein, will become apparent from a consideration of the drawings and ensuing description of the device and overall process of using powdered magnetic material in a fluid medium to induce electricity in a conductor.

### SUMMARY

In accordance with the present invention, a container “housing” enclosing a solid medium which will melt into a liquid containing powdered magnetic material, comprises a generator of electricity when a coil-core assembly mounted inside the housing is induced by the moving magnetic contents of boiling liquid to produce electricity. The basic process behind the machine is use of magnetic material suspended in a liquid to induce an electric current in a conductor in novel ways to harness electrical energy.

### DRAWINGS

Drawing Figures

FIG. 1 shows a front view of the REENERGY INDUCTOR (RI) assembled, as two sphere halves mated in closure as a housing of the coilcore assembly and other contents of the RI.

FIG. 2 shows a front exploded view of the coil-core assembly and the ceramic hemispheres which are brought together to enclose the coil-core assembly and other contents of the RI.

FIG. 3 shows a top view, looking down on the coil-core assembly mounted on notches in the bottom hemisphere before enclosure with the top hemisphere.

FIG. 4 shows an exploded side view of the device before mating of the two ceramic hemispheres, and the mounting of the coil-core assembly on the two equidistant notches on the bottom hemisphere.

### REFERENCE LETTERS IN DRAWINGS

a. Top Ceramic Hemisphere

b. Bottom Ceramic Hemisphere

c. Notches on b on which the Coil-Core Assembly is mounted

d. Square-shaped Prongs of the core metal piece

e. 8 in. long core metal piece

f. Top holes in e, which slant 45 degrees to join with end prong holes

g. End Prong Holes, which form 2 tunnels with f

h. 18 gauge uninsulated, tinned copper wire

i. Coil of h around cylinder of core metal piece e

NOT PICTURED: additional contents of the RI include paraffin wax dried in place in both ceramic hemispheres, bearing finely powered Fe₃O₄ (Magnetite) as described below, which when placed in heat will melt and boil.

### DETAILED DESCRIPTION

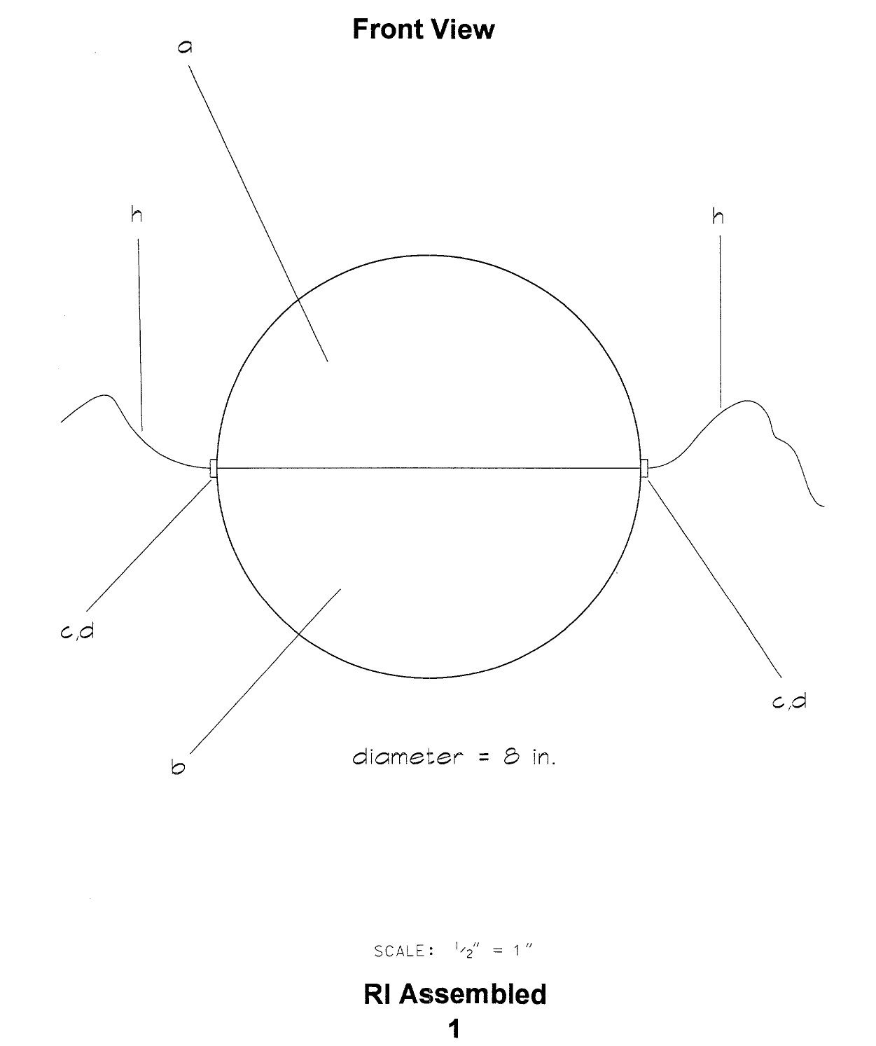

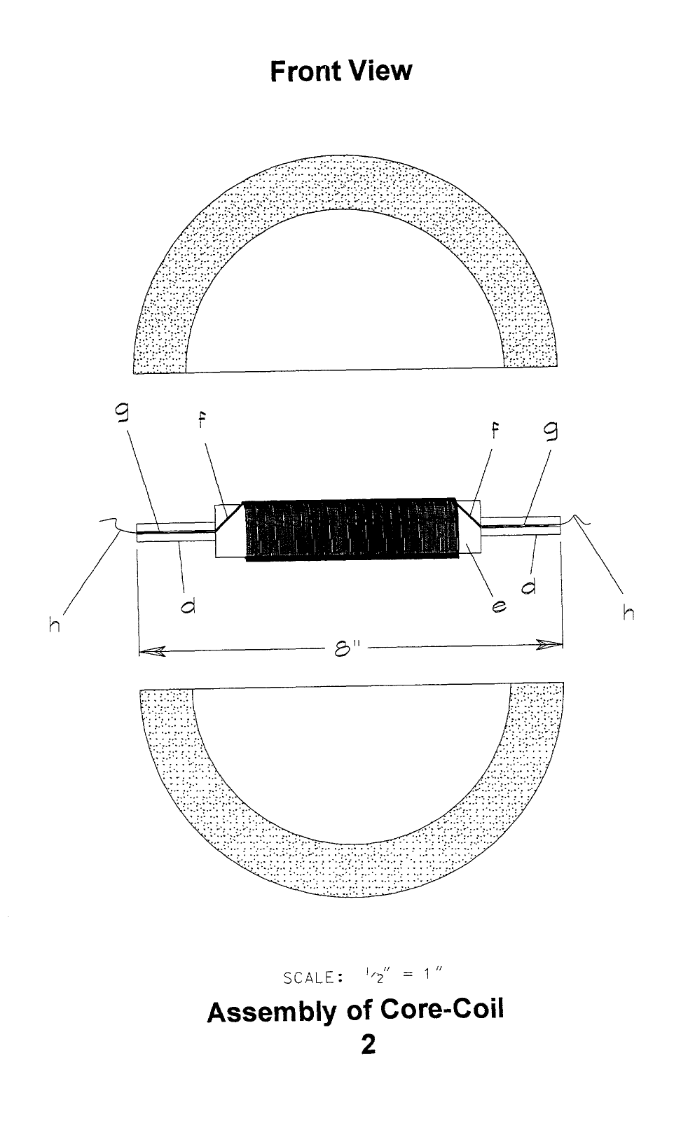

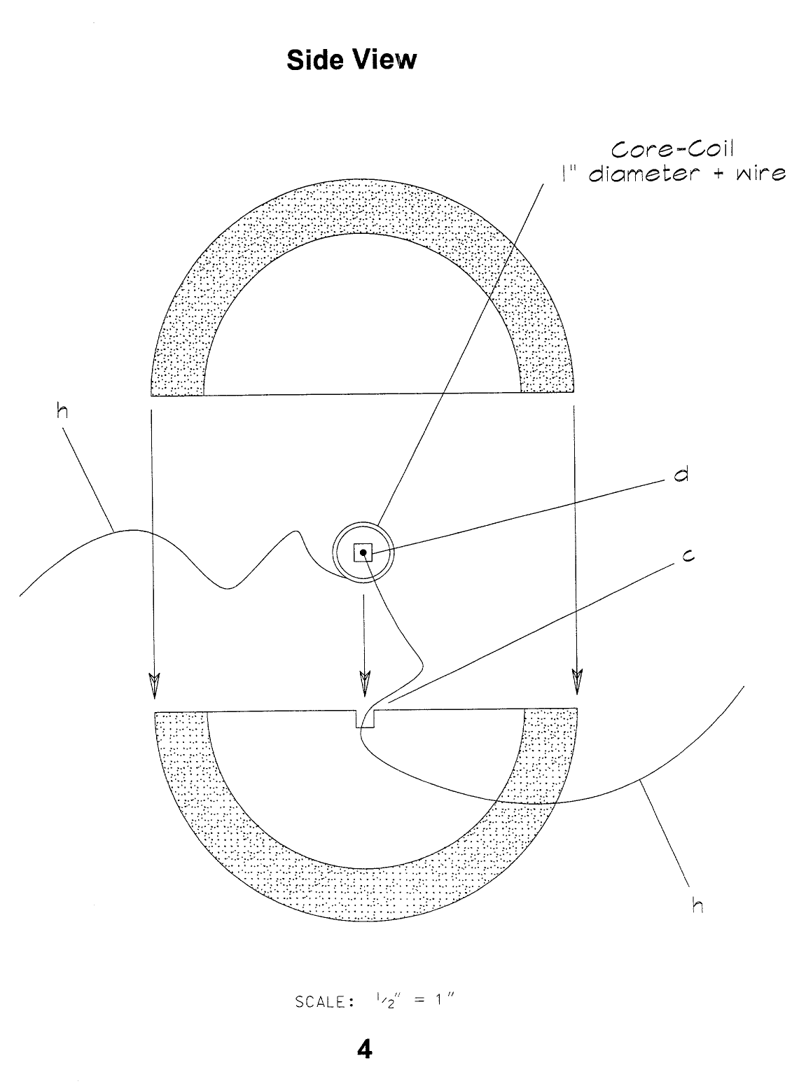

Description—FIGS. 1-4—Preferred Embodiment

The prototype device is designed to be placed in any area of 200-600 degrees F ambient heat and to convert that heat into usable electrical current. This process takes place without the necessity of steam or steam turbine technology, the nearest prior art known to the inventor. Hence this REENERGY INDUCTOR (hereinafter referred to as the RI technology may prove more efficient than steam conversion.

The object of the RI is to create a commercially feasible way to use factory waste heat, heat from industrial plants, heat from geothermal sites, and from conventional ovens, etc. to produce, reclaim and/or recycle electrical energy. Heat is energy in a disorganized state which the RI can better reform into electricity than steam production. Many industries which waste heat today could be encouraged to recycle it into electricity using the inexpensive RI. The RI is currently designed in a spherical shape which can be bundled with other units and wired together for maximum current in a given area of ambient heat. Estimated cost of the prototype was approximately $300, and would certainly decrease with mass production. Testing must be done to determine 1) the amount of current which may be obtained at various temperatures of heat; and 2) the durability of the product. The RI consists of the following parts which are depicted in the drawings (NOTE: ALL DRAWINGS ARE DRAWN AT ½ SCALE):

A. Ceramic Housing

1. Bottom Hemisphere (with two notches)

2. Top Hemisphere

B. Core-Coil Assembly

1. Metal Piece (with tunnels drilled for wire passage)

2. 50 ft. 18 gauge uninsulated copper tinned wire

C. Contents (Not pictured):

1. Paraffin wax (melted to liquid)

2. 1.4 Micron Magnetite Fe₃O₄ powder (from Pea Ridge Iron Ore Co., Sullivan, Mo.)

The hardware is sealed and assembled carefully using JB Weld glue, which is rated to 600 degrees F. Later testing may involve different glues, parts, and temperatures. For instance, titanium or other material might be favored over ceramics. The prototype when assembled is a 8” diameter sphere with connecting wire protruding on either side. These wires will be connected to a modest test circuit to measure current, voltage, etc. under conditions of heat. In commercial practice, the wires would lead into adaptive circuitry leading into an existing power grid.

### STRUCTURE OF INVENTION

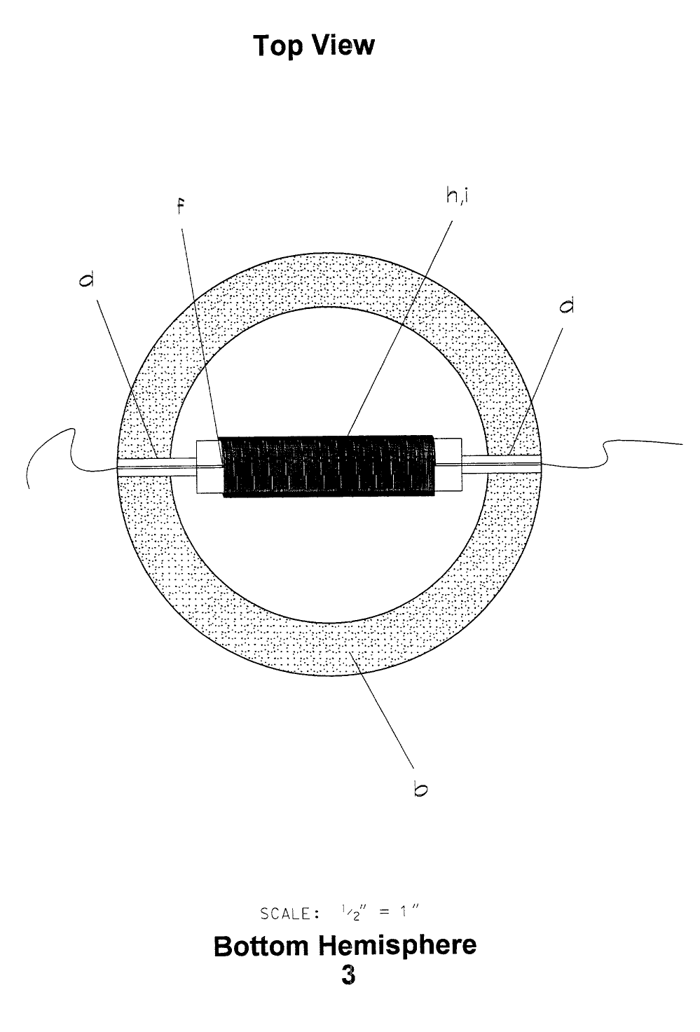

The two ceramic hemispheres a and b (fashioned using Valcones Clay from Armadillo Clay, Austin, Tex.) create a ceramic housing for the internal parts and contents of the device, which will experience hundreds of degrees of heat. The bottom hemisphere (b) features two notches c (⅓ in.×⅓ in.) which accommodate the squared prongs (d) of the metal piece (e). The metal piece (e) is cylindrical in its middle five inches, with the prongs 1 ½ in. in length and square-shaped. The width of the square prongs is ⅓ in. The metal piece has two holes drilled on each side, one from the top (f) (about 1.5 mm diameter) slanting down into the other hole (g), which is drilled straight in through the end of the prong (about 3 mm diameter). Both sides feature one of these tunnels (f, g). They are designed for the ingress and egress of 18 gauge uninsulated wire (h), which is wound on the cylinder of the core metal piece to form a coil (I). Experimentation will be done to determine the optimum winding in future prototypes; other metals, gauges, and types of conductors may be utilized. Once the wire is threaded through one of the tunnels, the wire is wound tightly on the core into one or more layers, with the assistance of glue. The end of the wire is then threaded out the other tunnel. All holes and parts to be joined are carefully sealed with glue. This completes the Coil-Core Assembly (see drawing, “Top View,” FIG. 3).

Next the core-coil assembly is mounted onto the two equidistant notches of the bottom hemisphere (d), using liberal amounts of glue. The contents (paraffin wax and Fe₃O₄ powder) are melted and mixed vigorously over stove heat. A sludge will tend to collect on the bottom, while the lighter iron particles are washed out and suspend in the wax. These powder particles are highly magnetic. The top of the mixture is quickly poured off into each of the two hemispheres and allowed to dry.

The next crucial step is to mate the two hemispheres, using plenty of glue in putty-like fashion to seal the device. The glue is allowed to dry 48 hours. Future prototypes using different housing materials may have a welded, rather than glued housing.

When the RI is placed in heat sufficient to move the paraffin and Fe₃O₄ particles (predicted at 345-600 degrees F), the RI will contain a moving magnetic field around an induction coil, which will induce an electric current in the wire in accordance with Faraday's Law of Electromagnetic Induction. At boiling temperature, this motion will become intense, and the current will increase accordingly. Testing must be done to determine how much current can be obtained per unit of temperature. In commercial practice, the DC current which is anticipated to be produced can be converted to useful AC by use of inverter circuitry. If sufficient power is produced, a factory may have the option of recycling heat into electrical power back into their own electrical system, or selling it off to a power company. In either case, conservation of energy is encouraged. Of course, such is the public policy of the federal government. As I experiment in testing with different materials, the maximum temperatures the RI can utilize may increase.

### ALTERNATIVE EMBODIMENTS

The REENERGY INDUCTOR is offered as but one embodiment of the REENERGY INDUCTION technology. The process of REENERGY INDUCTION can and will take many forms. The basic principle behind all REENERGY INDUCTION technology is the novel process of applying Faraday's Law of Electromagnetic Induction to finely powdered magnetic material mixed with a turgid fluid to create relative motion between the moving magnetic field and a conductor such as wires or coils (or simple metal pieces). The inventor seeks broad patent protection for any such process of utilizing magnetic material in a fluid medium to induce electricity for use, as well as for the specific machine presented in this patent application.

The inventor is currently negotiating with Houston Advanced Research Center (HARC) concerning testing of the device. Upon testing I may learn the optimum size for the RI with regard to electrical output, and later prototypes may reflect this. One RI unit the size of the prototype may produce a certain electrical output; but many units can be wired together like a cluster of grapes to produce more substantial energy generation. Or, larger prototypes may prove more efficient.

The size of the magnetic field which will be produced in the RI is currently unknown; but testing may show that induction coils can actually be efficaciously placed on the outside of the ceramic sphere or other housing and produce electricity by induction. Perhaps the entire sphere could be wrapped in wire, which joins with the connecting wire from inside the device, increasing dramatically the overall energy output.

The RI may prove better suited to a different shape than a sphere; testing may provide more information about this. The coil and core may be modified in design to maximize their utility and efficiency, and different media including but not limited to water, mineral oil, silicone, etc. may be utilized to bear the magnetic material.

Water may be used as a medium to propel magnetic powder through a hose which is wrapped with coiled wire. Taking advantage of the hydrodynamic motion of water through the hose and recycling the action of the water/magnetic material may induce enough electricity in the surrounding wire so that a human- or animal-powered machine circulating the water can practically generate electricity. Or, the siphoning effect may be used to prime water in a circuit which will produce electrical energy with a minimum of preparatory work.

### ADVANTAGES

From the description above, a number of advantages of my REENERGY INDUCTION process and REENERGY INDUCTOR become evident:

(a) The use of powdered magnetic material provides a way to induce electricity without the needs to turn heavy mechanical parts; the generator does its work through the convection effect of ambient heat boiling the paraffin medium. In the case of the REENERGY INDUCTION process, properties unique to fluid- and hydrodynamics may make this process very efficient using water as a medium without the need to heat the device; or, perhaps steam could actually propel the powdered magnetic material past coils with such force that a considerable current is induced. Because of the many potential applications for the technology, patent protection is warranted for the process of REENERGY INDUCTION as well as the specific REENERGY INDUCTOR. My claims reflect this need for broad protection.

(b) The prototype of the RI was very inexpensive to produce. With some product development and mass production, the cost would come down even more, and would easily challenge the cost of expensive steam production.

(c) The prototype is designed to be airtight and sealed from leakage. Subsequent designs may experiment with sealed “hatches” or openings which would give access to replenish the paraffin and/or magnetite supply in the housing. If internal gas pressure buildup proves to be a problem, a relief valve may be designed to lessen the pressure; perhaps recycling the gas back into the system when it has cooled could enhance convection and motion of the magnetic field.

### CONCLUSION, RAMIFICATIONS, AND SCOPE

The REENERGY INDUCTOR is inexpensive, cost effective, and easy to fabricate and operate. It is an innovative energy conservation/reclamation device that can be sold to factories and consumers alike. There are tens of thousands of commercial sites around the world which could use RI and REENERGY INDUCTION technology to save money in energy costs. There are millions of conventional consumer and commercial ovens around the world which could use the RI. Perhaps even campers and the military could use the RI over campfires as an inexpensive generator. A factory using the RI can reclaim electrical energy from waste heat and then feed it back into its own electrical power grid; or, it can sell the extra energy to a power company. Some examples of high-heat sources which could call for RI technology include: a) volcanic and geothermal sites; b) nuclear reactors; c) natural gas burnoff; d) steel/metal foundries; e) chemical processing plants; f) food processing plants; g) oil refineries; h) plastic fabrication plants; i) heat-treatment plants. In a changing energy landscape, the world is looking for ways to save energy and money. The RI enables businesses and consumers alike to reclaim energy from heat which would otherwise be lost, and does not require massive mechanical work like steam and steam turbines. It is compact, simple to use, and the materials which go into the manufacturing ot the RI are cheap and plentiful. With a little engineering know-how, the RI will fill a market niche which nothing else has been able to fill. The process of REENERGY INDUCTION, putting Faraday's Law of Electromagnetic Induction into action through a novel approach, could launch a broad technology which will save a tremendous amount of otherwise wasted energy. The inventor respectfully requests a patent covering any process which involves electromagnetic induction using magnetic materials borne on a liquid medium moving relative to a conductor.

I claim:

1. A process for generation of electricity, comprising,
a. magnetic material borne by a liquid medium, and
b. said magnetic material borne by said medium to move relative to a conductor of electricity, and
c. means for inducing electricity in said conductor whereby said electricity will be conveyed by said conductor for use.

2. A generator of electricity, comprising
a. a container for enabling heating of an enclosed medium from solid to liquid form,
b. magnetic material borne by said medium to move relative to a conductor of electricity mounted within said container, and
c. means for inducing electricity inside said container whereby said electricity will be conveyed by said conductor outside said container for use.
